(19) United States
(12) Patent Application Publication
(10) Pub. No.: US 2014/0177201 A1
(43) Pub. Date: Jun. 26, 2014

(54) ILLUMINATION APPARATUS USING LASER DIODE AS LIGHT SOURCE

(71) Applicant: HON HAI PRECISION INDUSTRY CO., LTD., New Taipei (TW)

(72) Inventor: YI-ZHONG SHEU, New Taipei (TW)

(73) Assignee: HON HAI PRECISION INDUSTRY CO., LTD., New Taipei (TW)

(21) Appl. No.: 13/875,299

(22) Filed: May 2, 2013

(30) Foreign Application Priority Data
Dec. 24, 2012 (TW) 101149420

(51) Int. Cl. F21K 99/00

(52) U.S. Cl. CPC F21K 9/56
USPC 362/84

(57) ABSTRACT

An illumination apparatus includes a laser diode and an encapsulation layer located at one side of the laser diode. A plurality of fluorescent powders is mixed in the encapsulation layer. A reflecting layer is provided. Light generated by a mixture of light generated by the laser diode and light generated by the fluorescent powders by excitation of the light generated by the laser diode has a part radiating out of the encapsulation layer after it is reflected by the reflecting layer.

### BACKGROUND

1. Technical Field

The present disclosure relates generally to an illumination apparatus, and more particularly to an illumination apparatus which uses a laser diode as a light source.

2. Description of Related Art

LEDs (light emitting diode) have been widely promoted as light sources of electronic devices owing to many advantages, such as high luminosity, low operational voltage and low power consumption. However, during operation of the LED, the LED converts the power into optical energy, also converts into heat energy. Thus, the photoelectric conversion efficiency of the LED is not high. Laser diodes have a photoelectric conversion efficiency which is higher than LEDs.

Therefore, an illumination apparatus which uses a laser diode as a light source is desired.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 shows a cross-sectional view of an illumination apparatus in accordance with a first embodiment of the present disclosure.

FIG. 2 shows a cross-sectional view of an illumination apparatus in accordance with a second embodiment of the present disclosure.

### DETAILED DESCRIPTION

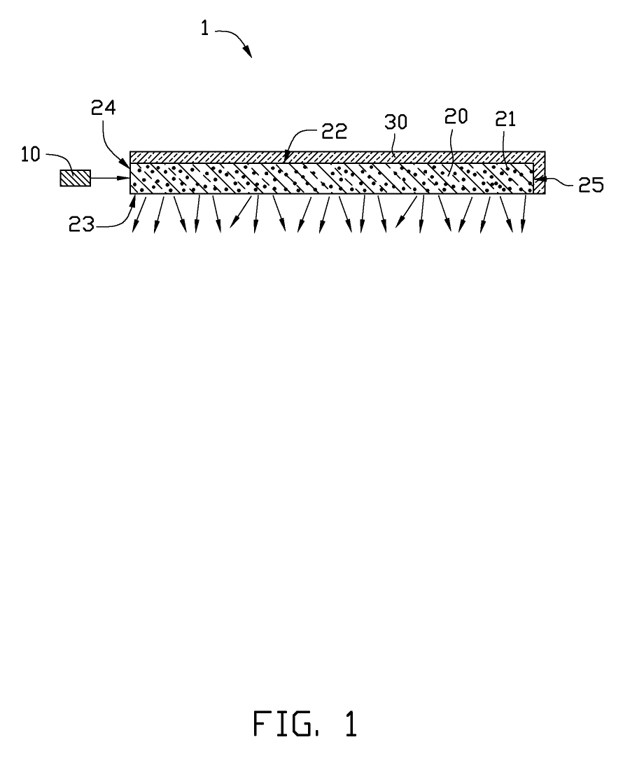

Referring to FIG. 1, an illumination apparatus 1 in accordance with a first embodiment of the present disclosure includes a laser diode (LD) 10, an encapsulation layer 20 located at a side of the laser diode 10 and in alignment with the laser diode 10 along a horizontal direction and a reflecting layer 30 coated on the encapsulation layer 20. The encapsulation layer 20 is a rectangular parallelepiped.

A luminescence spectrum of the laser diode 10 is narrow, and the light emitted from the laser diode 10 is concentrated, whereby it is difficult to be intervened when it transmits through the air or other medium. The laser diode 10 mostly converts electric energy into optical energy, and hardly converts into heat energy, so the photoelectric conversion efficiency of the laser diode 10 is high. In this embodiment, light emitted from the laser diode 10 is blue light.

The encapsulation layer 20 is located at one side of the laser diode 10, and is further mixed with fluorescent powder 21 therein. In this embodiment, the fluorescent powder 21 is yellow fluorescent powder. The encapsulation layer 20 includes a top surface 22, a bottom surface 23 opposite to the top surface 22, a left lateral surface 24 and a right lateral surface 25 opposite to the left lateral surface 24. The laser diode 10 is adjacent to the left lateral surface 24 of the encapsulation layer 20 and distant from the right lateral surface 25. A space is defined between the laser diode 10 and the left lateral surface 24.

The reflecting layer 30 is attached on the top surface 22 and the right lateral surface 25 of the encapsulation layer 20, and the cross-section of the reflecting layer 30 is L-shaped. Alternatively, the reflecting layer 30 can also cover a front side surface and a rear side surface of the encapsulation layer 20, whereby more light can be directed downwardly.

In use of the illumination apparatus 1, when the blue light emitted from the laser diode 10 is entered to an interior of the encapsulation layer 40 from the left lateral surface 24, the fluorescent powder 21 in the encapsulation layer 20 is excited by a part of the blue light and generates yellow light. Then, the other part of the blue light is mixed with the yellow light to form the white light. A part of the white light is output directly from the bottom surface 23 and the front and rear side surfaces of the encapsulation layer 20. The other part of the white light is transmitted to the top surface 22 and the right lateral surface 25 of the encapsulation layer 20, reflected by the reflecting layer 30 and finally output from the bottom surface 23 and the front and rear sides surfaces of the encapsulation layer 20, whereby the illumination apparatus 1 generates a linear illumination field. The illumination apparatus 1 can replace a conventional fluorescent tube.

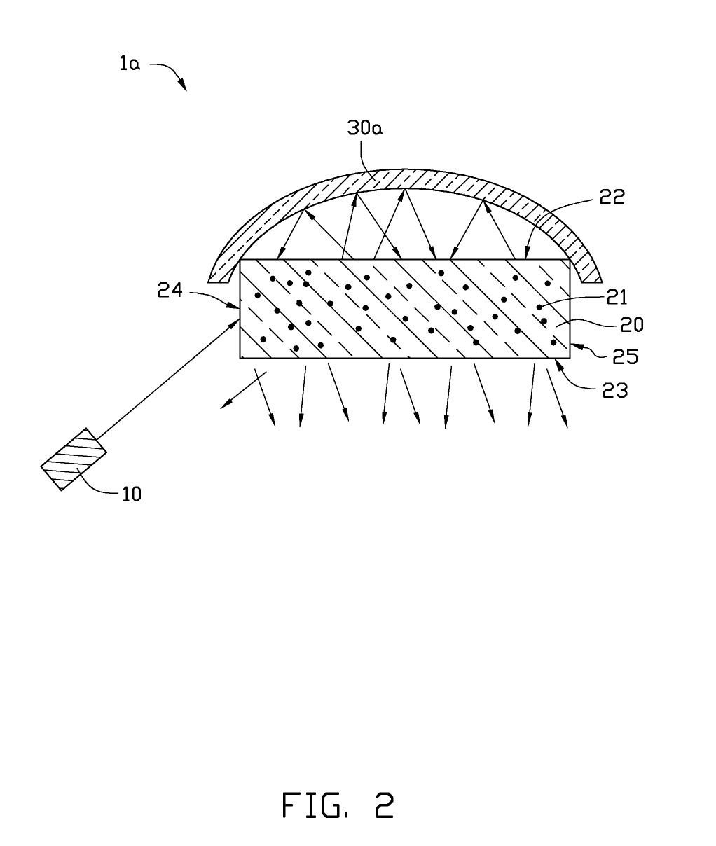

Referring to FIG. 2, an illumination apparatus la in accordance with a second embodiment of the present disclosure is similar to the illumination apparatus 1. The difference between the illumination apparatus 1a and the illumination apparatus 1 is that, the laser diode 10 is located at the lower left of the encapsulation layer 20, and the reflecting layer 30a correspondingly covers the top surface 22 of the encapsulation layer 20, and the cross-section of the reflecting layer 30a is arcuate. The reflecting layer 30a is configured like a dome. Furthermore, the encapsulation layer 20 is configured like a disc. When the blue light emitted from the laser diode 10 is entered to the interior of the encapsulation layer 40 from the left lateral surface 24, the fluorescent powder 21 in the encapsulation layer 20 is excited by a part of the blue light and generates yellow light. Then, the other part of the blue light is mixed with the yellow light to form the white light. Thus, part of the white light is output from the bottom surface 23 of the encapsulation layer 20. The other part of the white light is transmitted to the reflecting layer 30a, reflected by the reflecting layer 30a to move downwardly and finally output from the bottom surface 23 of the encapsulation layer 20, whereby the illumination apparatus 1a generates a circular illumination filed. The illumination apparatus 1a of the second embodiment can replace a conventional light bulb.

Particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An illumination apparatus, comprising:
a laser diode; and
an encapsulation layer located at one side of the laser diode;
a plurality of fluorescent powders mixed in the encapsulation layer; and
a reflecting layer;
wherein first light generated by the laser diode has a first color, the first light enters the encapsulation layer to excite the fluorescent powders to generate a second light having a second color, the first light mixes with the second light to generate a third light having a third color, the third light has a part directly radiating out of the encapsulation layer and another part radiating out of the encapsulation layer after being reflected by the reflecting layer.

2. The illumination apparatus of claim 1, wherein the encapsulation layer is a rectangular parallelepiped and comprises a top surface, a bottom surface opposite to the top surface, a left lateral surface and a right lateral surface opposite to the left lateral surface, and the laser diode faces towards and is spaced from the left lateral surface of the encapsulation layer.

3. The illumination apparatus of claim 2, wherein the reflecting layer is formed on the top surface and the right lateral surface of the encapsulation layer.

4. The illumination apparatus of claim 3, wherein a cross-section of the reflecting layer is L-shaped.

5. The illumination apparatus of claim 1, wherein the encapsulation layer is a disc and comprises a top surface, a bottom surface opposite to the top surface, a left side and a right side opposite to the left side, the laser diode is located at a lower left of the encapsulation layer.

6. The illumination apparatus of claim 5, wherein the reflecting layer is formed above the encapsulation layer and covers the top surface of the encapsulation layer.

7. The illumination apparatus of claim 6, wherein a cross-section of the reflecting layer is arcuate and the reflecting layer is configured as a dome.

8. The illumination apparatus of claim 1, wherein the first color of the first light emitted from the laser diode is blue, and the fluorescent powders are yellow fluorescent powders.

9. The illumination apparatus of claim 1, wherein the laser diode is spaced from the encapsulation layer.
